(19) United States
(12) Patent Application Publication
(10) Pub. No.: US 2026/0122540 A1
(43) Pub. Date: Apr. 30, 2026

(54) METHOD FOR CONDUCTING A BIDIRECTIONAL RADIO COMMUNICATION, RADIO COMMUNICATION NETWORK AND RADIO NODE

(71) Applicant: Diehl Metering Systems GmbH, Nürnberg (DE)

(72) Inventors: Matthias Adelhard, Ansbach (DE); Charles Fendt, Stein (DE)

(21) Appl. No.: 19/359,872

(22) Filed: Oct. 16, 2025

(30) Foreign Application Priority Data
Oct. 24, 2024 (DE) 102024131015.4

(51) Int. Cl. H04W 28/18; H04L 5/00; H04L 67/12; H04W 88/16

(52) U.S. Cl. CPC H04W 28/18; H04L 5/0048; H04L 67/12; H04W 88/16

(57) ABSTRACT

A method for conducting a bidirectional radio communication between a radio node and a gateway is performed in a radio communication network that includes at least one, preferably a plurality, of radio nodes, which are preferably operated by a battery, and at least one gateway, in which the radio communication occurs in an IMS frequency band and the radio node has a default setting of the application layer in which a defined volume of data is transmitted in the uplink from the radio node to the gateway. A change of the setting of the application layer in the radio node that occurs due to a downlink message during operation of the radio node reduces the volume of data that is subsequently transmitted in the uplink from the radio node to the gateway, compared to operation of the radio communication network that occurs with the default setting of the application layer.

### CROSS-REFERENCE TO RELATED APPLICATION

This application claims the priority, under 35 U.S.C. § 119, of German Patent Application DE 10 2024 131 015.4, filed Oct. 24, 2024; the prior application is herewith incorporated by reference in its entirety.

### FIELD AND BACKGROUND OF THE INVENTION

The invention relates to a method for conducting a bidirectional radio communication between a radio node and a gateway in a radio communication network that includes at least one, preferably a plurality, of radio nodes, which are preferably operated by a battery, and at least one gateway, and in which the radio communication occurs in an IMS (Industrial, Scientific and Medical) frequency band and the radio node has a default setting of the application layer in which a defined volume of data is transmitted in the uplink from the radio node to the gateway. The present invention also relates to a radio communication network having at least one, preferably a plurality, of radio nodes, which are preferably operated by a battery, at least one gateway, and a headend. The present invention further relates to a radio node operated according to the method.

In particular, the present invention involves radio communication networks for reading consumption data in applicable supply networks (e.g. water, gas, electricity or heat) and/or for operating communal installation facilities (“smart city”). The radio node, e.g. a smart meter, transmits its data, e.g. consumption data, to at least one gateway within the radio communication network periodically at certain times. In addition, the radio node can send its data over different ranges in different modes. Sending over different ranges may be linked to the regularity of sending. For example, data can be sent more regularly in a short range area than in a long range area or in a very long range area.

There are special requirements for operating such radio communication networks. On the one hand, the energy consumption of the radio nodes should be as low as possible, since they are operated with a battery, in particular a longlife battery. A radio node should therefore be able to function with no maintenance for at least 10 years “in the field” without having to replace the battery. For that reason, the radio nodes send only at certain times. Furthermore, there is a risk of interference with reception due to external sources of interference or “collisions” between data packets (telegrams) during transmission (“collision in the air”). For that reason, uplink telegrams, i.e. telegrams from the radio node to the gateway, having the same content are sent multiple times in order to improve the probability of reception. That can increase the probability of reception. However, that in turn increases energy consumption in the radio node. Reception of the data in the gateway is made even more difficult by the fact that the data transmission occurs in particular in a narrowband ISM frequency band.

In order to ensure sufficient efficiency for the data transmission, previous measures have resided in increasing the number or density of gateways in a radio communication network in order to increase reception quality. In addition, telegrams are transmitted using the so-called telegram splitting method. That involves telegrams being divided into subpackets and sent using different frequencies. The information in the telegram is extracted from the individually received subpackets in the gateway or in the headend.

In addition, attempts have heretofore been made to reduce the number of collisions between data packets by adjusting the baud rate for uplink data transmission. However, that requires special downlink commands at the radio nodes, i.e. a change of the transport layer.

### SUMMARY OF THE INVENTION

It is accordingly an object of the invention to provide a method for conducting a bidirectional radio communication, a radio communication network and a radio node, which overcome the hereinafore-mentioned disadvantages of the heretofore-known methods and devices of this general type and which have increased efficiency.

With the foregoing and other objects in view there is provided, in accordance with the invention, a method for conducting a bidirectional radio communication between a radio node and a gateway in a radio communication network that includes at least one, preferably a plurality, of radio nodes, which are preferably operated by a battery, and at least one gateway, and in which the radio communication occurs in an IMS frequency band and the radio node has a default setting of the application layer in which a defined volume of data is transmitted in the uplink from the radio node to the gateway, a change of the setting of the application layer in the radio node that occurs due to a downlink message during operation of the radio node reduces the volume of data (volume of data per unit time) that is subsequently transmitted in the uplink from the radio node to the gateway, compared to operation of the radio communication network that occurs with the default setting of the application layer.

Expedient embodiments of the present invention are recited in the dependent claims.

This method can reduce the on-air time of uplink telegrams of the radio communication network, thereby reducing the risk of collisions between data packets, resulting in bandwidth optimization. At the same time, the battery of the radio nodes, which is preferably a longlife battery, can be effectively conserved. Due to the shorter on-air time of uplink telegrams after adjustment of the application layer, the density of radio nodes in the reception range of the radio communication network and thus the performance thereof can be increased. The aforementioned effects result in a better SLA (Service Level Agreement). The SLA describes the level of automatic reading of radio nodes in the radio communication network. For example, an “SLA of 95” means that 95% of the radio nodes can be read automatically.

According to an expedient embodiment of the present invention, the change of the setting of the application layer can be triggered by way of a downlink message to the radio node. Reception of the downlink message is thus the trigger event for the change of the application layer in the radio node.

According to an expedient embodiment of the present invention, the downlink message for changing the setting of the application layer in the radio node can be defined or provided in the headend. This downlink message can be transmitted from the headend to the relevant radio node via the relevant gateway.

According to an expedient embodiment of the present invention, the volume of data can be reduced by reducing the regularity of the uplink telegrams to be sent by the radio node and/or by reducing the payload or length of the uplink telegrams to be sent by the radio node and/or by extending the transmission intervals for the uplink telegrams to be sent by the radio node. The “transmission intervals” refer to the respective interval of time between successive transmission times for uplink telegrams of the radio node.

According to an expedient embodiment of the present invention, the volume of data transmitted in the uplink or the payload or length of the uplink telegrams to be transmitted by the relevant radio node can be reduced by:
using at least two different radio modes to send uplink telegrams in the default setting of the application layer of the radio nodes during operation and deactivating at least one radio mode or a radio mode in the radio node when the setting of the application layer is changed, and/or
sending uplink telegrams in specified transmission intervals in the default setting of the application layer of the radio nodes, and
extending the transmission intervals when the setting of the application layer is changed, and/or
sending uplink telegrams having a specified payload or a specified telegram length in the default setting of the application layer of the radio node and reducing the payload or shortening the telegram length when the setting of the application layer is changed.

According to an expedient embodiment of the present invention, the at least two different radio modes can have different radio ranges and/or different transmission intervals. Preferably, the different radio modes are modes of the OMS (Open Metering System) specification.

According to an expedient embodiment of the present invention, the at least two different radio modes can include a short range mode, a middle range mode and/or a long range mode.

According to an expedient embodiment of the present invention, redundancy-related data can be transmitted in the uplink telegram in the default setting of the application layer of the radio node, and the redundancy-related data can be reduced or no longer included in the uplink telegram when the setting of the application layer in the radio node is changed. The redundancy-related data can be additional data that are transmitted in the payload of the uplink telegram as an additional payload besides current data, e.g. current consumption levels.

According to an expedient embodiment of the present invention, the aforementioned redundancy-related data can be consumption levels that have been read at least at two different reading times (also called “due dates”) and stored in the radio node. During basic operation of the application layer of the radio node, such redundancy-related data are sent repeatedly over longer periods of time (e.g. over three months).

According to an expedient embodiment of the present invention, the change of the setting of the application layer in the radio node can be made when the radio node sends uplink telegrams using at least two different radio modes, preferably using a plurality of radio modes, in the default setting of the application layer and uplink telegrams of at least one of the radio modes are received by the gateway. Since reception occurs, it is then no longer absolutely necessary to use the additional radio mode or modes for future uplink telegrams.

Alternatively or additionally, the change of the setting of the application layer in the radio node can also be made when the radio node sends uplink telegrams using at least two different radio modes, preferably using a plurality of radio modes, in the default setting of the application layer and uplink telegrams of at least one radio mode are not received by the gateway. In this case, the uplink telegrams sent by the radio node but not received by the gateway can be deactivated in the radio node, so that only uplink telegrams that can be received by the radio node are then sent.

Additionally or alternatively, the change of the setting of the application layer in the radio node can be made if the radio node sends uplink telegrams with redundancy-related data in the default setting of the application layer during normal operation and the headend confirms receipt of the redundancy-related data. If the headend thus confirms that the redundancy-related data have been received, the default setting of the application layer can be adjusted so that the redundancy-related data are no longer sent, but such data are sent only when new readings have taken place again.

According to an expedient embodiment of the present invention, the change of the setting of the application layer of the radio node can have no time limit.

Alternatively, the change of the setting of the application layer can have a time limit, the radio node subsequently switching back to normal operation for its application layer.

The time limit for the change of the setting of the application layer can be provided e.g. by the passage of time for a time window. Likewise, the radio node can switch back to the default setting of the application layer if it has received a corresponding downlink command or if it has not received a downlink command within a specified period of time. A change to the default setting can occur, for example, if the radio node is no longer received by the gateway, e.g. within a specified period of time.

According to an expedient embodiment of the present invention, the gateway can be a fixed gateway. The probability of successful automatic reading of radio nodes by a fixed gateway is already comparatively high, and so the data to be transmitted in a corresponding radio communication network can be reduced particularly easily by applying the present invention.

Alternatively, if necessary, the inventive method can also be applied in a radio communication network in which a mobile gateway is used.

According to an expedient embodiment of the present invention, the radio communication can advantageously occur in the 868 MHz frequency band. The associated frequency channels can be found in Appendix A to DIN EN 13757-4:2014-02. These are predominantly narrowband frequency ranges in which use of the present invention is of particular advantage, since the respective bandwidths can be used more efficiently as a result.

A radio node according to the present invention can preferably be a sensor node, for example a smart meter, or an actuator node, for example an actuator for operating a shut-off device (e.g. a slide or valve) for a commodity supply network, or a combination of a sensor node and an actuator.

The application layer can preferably be changed individually in a different manner for the individual radio nodes of a radio communication network. This is possible because the radio nodes in the downlink are individually selectable by using a specific ID.

With the objects of the invention in view, there is also provided a radio communication network, having at least one, preferably a plurality, of radio nodes, which are preferably operated by a battery, at least one gateway, a headend, and in which a method for conducting a bidirectional radio communication according to the invention takes place between the at least one radio node and the at least one gateway.

With the objects of the invention in view, there is concomitantly provided a radio node that is operated according to the inventive method.

According to an expedient embodiment of the present invention, the change of the setting of the application layer may be implemented in the firmware of the radio node and triggerable by way of the downlink command.

Other features which are considered as characteristic for the invention are set forth in the appended claims.

Although the invention is illustrated and described herein as embodied in a method for conducting a bidirectional radio communication, a radio communication network and a radio node, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of an arrangement of multiple radio nodes, a gateway and the headend as part of a radio communication network in a greatly simplified representation;

FIG. 2 is a block diagram of a radio node that sends uplink telegrams in a radio communication network having different radio modes, which have different ranges;

FIG. 3 is a diagram showing a first variant for changing the setting of the application layer in the radio node;

FIG. 4 is a diagram showing a second variant for changing the setting of the application layer in the radio node;

FIG. 5 is a diagram showing a third variant for changing the setting of the application layer in the radio node;

FIG. 6 is a diagram showing a fourth variant for changing the setting of the application layer in the radio node;

FIG. 7 is a diagram showing an illustrative greatly simplified representation of an uplink telegram with redundancy-related data;

FIG. 8 is a diagram showing an illustrative greatly simplified representation of an uplink telegram without redundancy-related data;

FIG. 9 is a table showing an illustrative representation of normal operation in the default setting of the application layer;

FIG. 10 is a table showing an illustrative representation of the change of the setting of the application layer of FIG. 9; and

FIG. 11 is a table showing an illustrative representation of a further change of the setting of the application layer of FIG. 9.

### DETAILED DESCRIPTION OF THE INVENTION

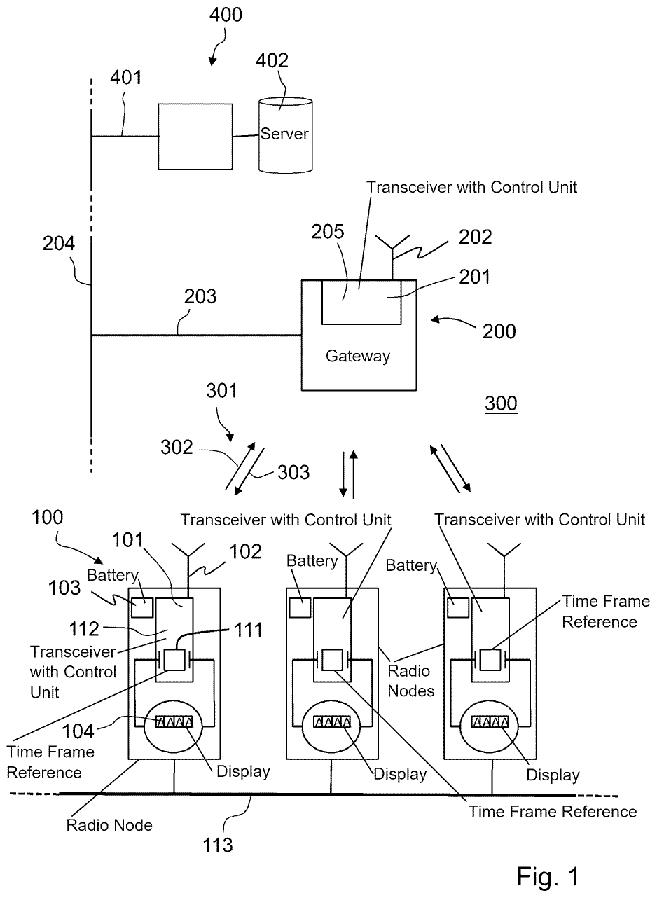

Referring now to the figures of the drawings in detail and first, particularly, to FIG. 1 thereof, there is seen a greatly simplified schematic illustration of a commodity supply network 113, which can be, for example, a supply network for water, gas, heat or electricity. In order to ascertain the consumption of the commodity of the commodity supply network 113 by specific users, a plurality of radio nodes 100 are installed in the commodity supply network 113. These are used to ascertain consumption quantities by way of suitable sensors and to transmit the consumption quantities to a headend 400 by radio.

The consumption data are evaluated and managed in the headend 400. For this purpose, the headend 400 includes a server 402, which, for example, can take the form of a web server or cloud server. The headend 400 is connected to the Internet 204 or web via a suitable communication channel 401.

The communication between the individual radio nodes 100 and the headend 400 occurs bidirectionally in an IMS band 301 via gateways 200, only one of which is shown in FIG. 1 for the sake of clarity. The respective radio node 100 transmits data or information to the respective gateway 200 by radio by way of uplink telegrams 302. Likewise, the respective gateway 200 transmits information or commands to the respective radio node 100 by way of downlink telegram 303. For this purpose, the respective radio node 100 includes a transceiver 101 having an antenna 102 and a control unit 112 for operating the radio node 100. The radio node 100 also has a time reference device 111 in the form of a crystal oscillator. In addition, the radio node 100 can have its own display 104.

The power source used in the radio node 100 is a battery 103, which is preferably configured as a so-called longlife battery. Such a longlife battery is intended to supply the radio node 100 with electrical energy “in the field” for a period of at least ten years.

The gateway 200 is also equipped with a transceiver 201 having an antenna 202 and having a control unit 205. The gateway 200 has a communication-capable connection to the headend 400 via a communication channel 203, such as the Internet 204 or web.

In a corresponding radio communication network 300, there can be provision for a multiplicity of radio nodes 100 and a plurality of gateways 200, through the use of which consumption data on a commodity are transmitted from the individual radio nodes 100 to the headend 400.

The quality of this automatic transmission with reference to the radio communication network 300 is shown in the level of the SLA. The consumption data are transmitted from the individual radio nodes 100 to the gateway 200 in the form of uplink telegrams 302 only at certain times in order to conserve the battery 103. The intervals between these transmission times are called “transmission intervals.” Between the transmission times, the radio node 100 is in an energy-saving sleep state.

Instead of a radio node for recording commodities, the radio node 100 can also be an actuator node or a combination of a sensor node and an actuator node.

Normal operation of the respective radio node 100 is defined by a default setting of the application layer of the radio node 100. In this case, a defined volume of data is transmitted from the radio node 100 to the gateway 200 in the uplink each time. The application layer is an abstraction layer that specifies the communication protocols used in the radio node 100. The application layer provides functions for the applications in the radio node, for example the data input and data output.

The normal operation defined by the default setting of the application layer of the radio node 100 can take different forms.

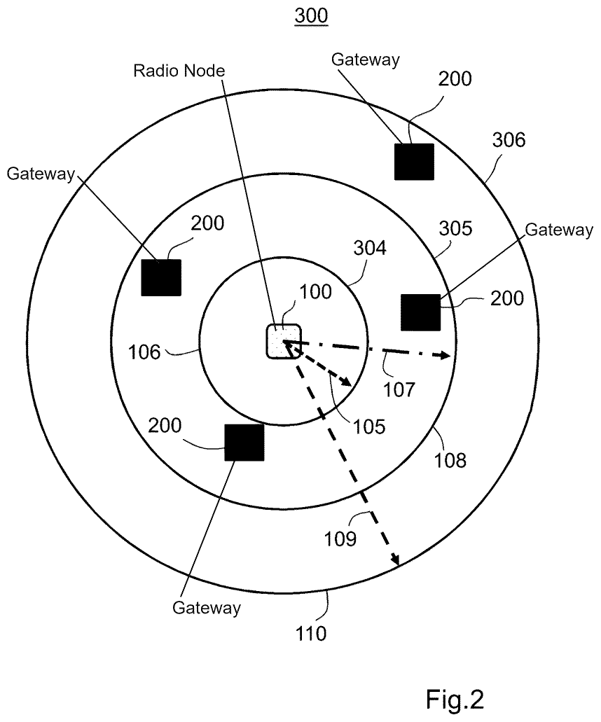

FIG. 2 shows, by way of illustration, a radio node 100 and a total of four gateways 200 of a radio communication network 300 that are in the range of the radio node. According to the default setting of the application layer of the radio node 100, the radio node sends uplink telegrams 302 in various modes, e.g. in a short range mode 105, a long range mode 107 and a very long range mode 109. The different modes are each identified in FIG. 2 by differently dashed arrows. The short range mode 105 has a range 106, the long range mode 107 has a range 108 and the very long range mode 109 has a range 110, each shown as circles in FIG. 2.

Each radio node 100 according to FIG. 1 thus sends, for example by way of these three modes 105, 107, 109, consumption data relating to transmission intervals, which are preferably different in each case. This action is permanently implemented in the application layer of the respective radio node 100. Due to the large number of radio nodes 100 in the radio communication network 300, a large number of uplink telegrams 302 are “on air” within a unit of time, which increases the risk of collisions and reduces the probability of reception. The concept of the present invention is to reduce the volume of data generated, thereby by changing the setting of the application layer in the radio node 100. There are various ways to do this.

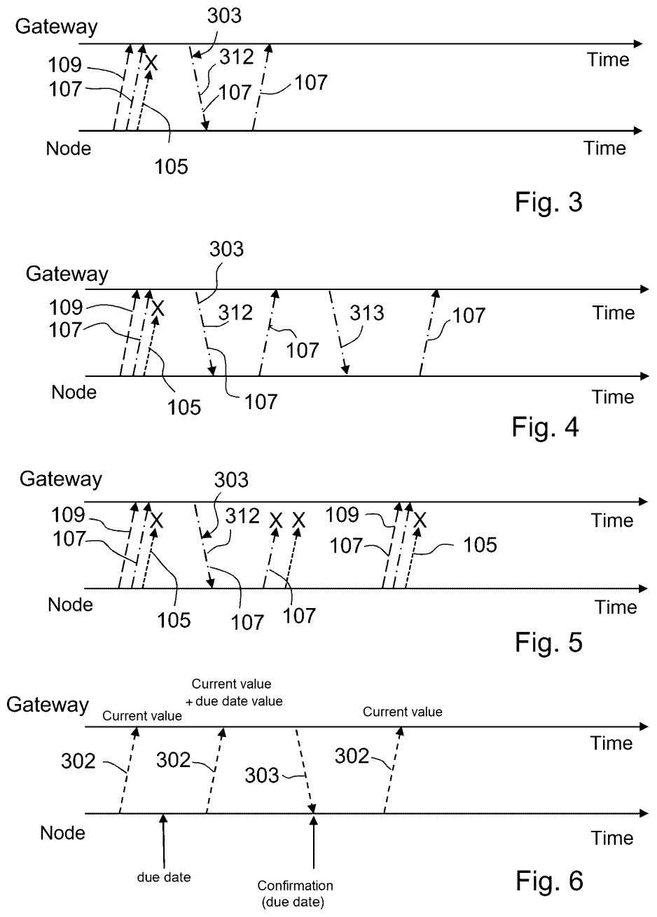

FIG. 3 shows an option to change the volume of data per unit time or the regularity of uplink telegrams 302 by adjusting the setting of the application layer in the radio node 100. The left-hand side of FIG. 3 shows individual uplink telegrams 302 in the different modes 105, 107, 109, which are also evident from FIG. 2. The relevant gateway 300 receives only uplink telegrams 302 of the modes 107 and 109, but not the uplink telegram 302 of the mode 105. The uplink telegrams 302 of the modes 107 and 109 received by the gateway 300 are transferred to the headend 400. The headend 400 stipulates that there be provision for a change of the default setting of the application layer in the radio node 100 by virtue of the relevant radio node 100 now sending only uplink telegrams 302 of the mode 107 but no longer additionally uplink telegrams 302 of the modes 105 and 109. The change of the setting of the application layer in the radio node 100 in this regard occurs in one step with a downlink telegram 303 in the form of a single downlink command or downlink telegram 312 with the new configuration. The change of the setting of the application layer of the radio node 100 has e.g. no time limit in the example of FIG. 3.

The change of the application layer according to FIG. 4 differs from that according to FIG. 3 in that after the downlink telegram 303 in the form of a downlink command or downlink telegram 312 with the new configuration, a further downlink telegram 313 with confirmation of the new configuration is sent to the radio node 100. In contrast to FIG. 3, which involves a configuration change in one step, the configuration change in FIG. 4 thus occurs according to the “attempt and confirmation” procedure, i.e. in two steps. When confirmation has been provided, operation of the radio node 100 is continued according to the changed setting of the application layer.

FIG. 5 shows an attempted change of the setting of the application layer of the radio node 100 according to the “attempt and failure” procedure. After the downlink telegram 312 with a new configuration has been received by the radio node 100, uplink telegrams 302 relating to the new configuration of the selected mode 107 are not received in the gateway 200, e.g. within a specified time. As a result, the relevant node 100 sends uplink telegrams 302 in the default setting of the application layer again, in the present example in the modes 105, 107 and 109. In this case, the system thus automatically returns to the default setting of the application layer.

FIG. 6 shows another example of the reduction of the volume of data per unit time according to the inventive method. Based on the default setting of the application layer, a current value, e.g. a current meter reading, is transmitted to the gateway 200 at certain transmission times using an uplink telegram 302. On a specific reading date (“due date”), the current value, e.g. the meter reading on the relevant reading day, is stored and additional current values with the respective current (running) value, e.g. meter reading, are transmitted in the uplink telegrams 302. These uplink telegrams 302, which contain the meter reading on the reading date, are transmitted to the gateway 200 as redundancy-related data at repeating intervals of time. This can be the case for redundancy reasons over a period of up to three months. Once the headend 400 has received these redundancy-related data, the present invention involves a downlink telegram 303 providing a confirmation of receipt of the meter reading for the reading date (“due date” value), whereupon a change of the setting of the application layer in the relevant radio node 100 occurs in such a way that subsequently only the current value is transmitted in its uplink telegrams 302. This can result in a significant saving in terms of the volume of data to be transmitted.

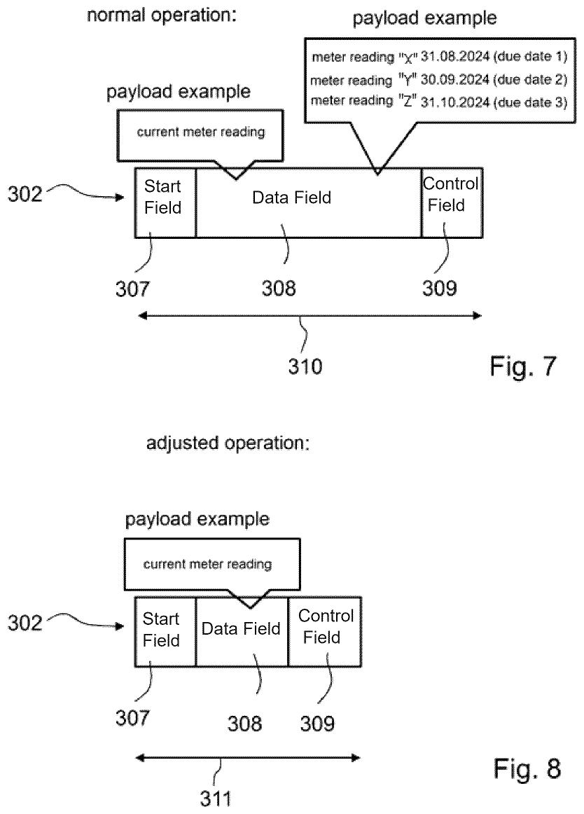

FIG. 7 shows, in relation to the procedure described in regard to FIG. 6, an illustrative frame of an uplink telegram 302 that contains the current meter reading and additionally meter readings X, Y, Z for the respective reading date (“due date”). The frame includes e.g. a start field 307, a data field 308 for the payload and a control field 309. The payload of the data field 308 contains the current meter reading and also, as redundancy-related data, the respective meter readings at three defined different reading times X, Y, Z and the respective “due date.” These reading times may be e.g. the last day of each of the last three consecutive months. These meter readings are additionally sent in the uplink telegrams 302. Consequently, they are additionally accommodated in the data field 308 as additional redundancy-related data. This is the default setting of the application layer of the radio node. The uplink telegram 302 has an increased telegram length 310 due to this payload. Periodically sending such uplink telegrams 302 therefore places significant load on the radio channel.

According to FIG. 8, a downlink telegram 303 confirms to the node 100 that the data regarding the “due dates” have arrived in the headend 400 and therefore no longer need to be transferred additionally as redundancy-related data. The node 100 thus changes the setting of the application layer in such a way that subsequently only uplink telegrams 302 of the type shown in FIG. 8 are then transmitted. These no longer contain the redundancy-related data, and so the telegram length 311 thereof is significantly shorter than the telegram length 310 of an uplink telegram 302 that corresponds to normal operation of the node.

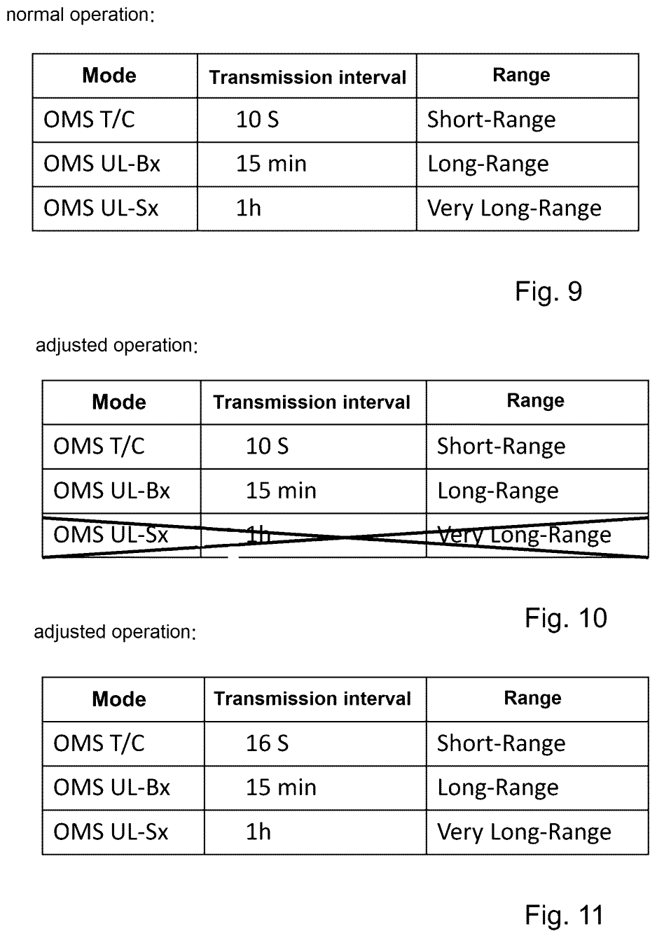

FIGS. 9 to 11 show further examples for reducing the volume of data to be transmitted. FIG. 9 shows normal operation using the different OMS modes (OMS T/C, OMS UL-Bx and OMS UL-Sx), which have different transmission intervals and also different ranges. This is the default setting of the application layer of the radio node 100.

If e.g. uplink telegrams 302 are received by the gateway 200 over the long range in the OMS UL-Bx mode, adjusted operation can involve the application layer of the radio node 100 being adjusted in such a way that uplink telegrams 302 are no longer sent with the OMS UL-Sx mode, as illustrated in FIG. 10.

Similarly, under the given conditions, adjusted operation can also be carried out in such a way that a transmission interval is extended in one mode compared to the default setting of the application layer. For example, the transmission interval of the OMS T/C mode is 10 seconds during normal operation according to FIG. 9. In contrast, it has been extended to 16 seconds during the adjusted operation according to FIG. 11.

Preferably, the gateway 200 is a gateway installed at a fixed location. However, the present invention is also suitable for use with a mobile gateway.

The present invention relates to radio communication in an IMS frequency band, see FIG. 1. In particular, the radio communication can occur in the 868 MHz frequency band. The associated frequency channels can be found in Appendix A to DIN EN 13757-4:2014-02. These are predominantly narrowband frequency ranges.

The change of the setting of the application layer may be implemented in particular in the firmware of the radio node 100 and triggerable by way of a downlink command 303.

The application layer can preferably be changed individually in a different manner for the individual radio nodes 100 of a radio communication network. This is possible because the radio nodes 100 in the downlink are individually addressable by using a specific ID.

Finally, it is pointed out that subcombinations of the described features or embodiments are also considered important to the invention.

The following is a summary list of reference numerals and the corresponding structure used in the above description of the invention:
100 radio node
101 transceiver
102 antenna
103 battery
104 display
105 short range mode
106 range of short range mode
107 long range mode
108 range of long range mode
109 very long range mode
110 range of very long range mode
111 time reference device
112 control unit
113 commodity supply network
200 gateway
201 transceiver
202 antenna
203 communication channel
204 Internet
205 control unit
300 radio communication network
301 IMS frequency band
302 uplink telegram
303 downlink telegram
304 short range mode
305 middle range mode
306 long range mode
307 start field
308 data field
309 control field
310 telegram length
311 telegram length
312 downlink telegram with new configuration
313 downlink telegram with confirmation of the new configuration
400 headend
401 communication channel
402 server

1. A method for conducting a bidirectional radio communication between a radio node and a gateway in a radio communication network, the method comprising:
providing the radio communication network, the radio communication network including at least one radio node, and at least one gateway carrying out the radio communication in an IMS (Industrial, Scientific and Medical) frequency band, the at least one radio node having a default setting of an application layer for transmitting a defined volume of data in an uplink from the at least one radio node to the at least one gateway; and
changing a setting of the application layer in the at least one radio node occurring due to a downlink message during operation of the at least one radio node, to reduce a volume of data to be subsequently transmitted in the uplink from the at least one radio node to the gateway, compared to operation of the radio communication network occurring with the default setting of the application layer.

2. The method according to claim 1, which further comprises using a battery to operate the at least one radio node.

3. The method according to claim 1, which further comprises using a downlink message to the at least one radio node to trigger the change the setting of the application layer.

4. The method according to claim 1, which further comprises using a headend to define the downlink message for changing the setting of the application layer in the at least one radio node.

5. The method according to claim 1, which further comprises reducing the volume of data by at least one of:
reducing a regularity of uplink telegrams, or
reducing a payload or length of uplink telegrams, or
extending transmission intervals for uplink telegrams of the at least one radio node.

6. The method according to claim 5, which further comprises reducing the volume of data transmitted in the uplink or the payload or length of uplink telegrams by at least one of:
using at least two different radio modes to send uplink telegrams in the default setting of the application layer of the at least one radio node during operation and deactivating a radio mode or at least one radio mode in the at least one radio node when the setting of the application layer is changed, or
sending uplink telegrams in specified transmission intervals in the default setting of the application layer of the at least one radio node, or
extending the transmission intervals when the setting of the application layer is changed, or
sending uplink telegrams having a specified payload or a specified telegram length in the default setting of the application layer of the at least one radio node and reducing the payload or shortening the telegram length when the setting of the application layer is changed.

7. The method according to claim 6, which further comprises providing the at least two different radio modes with at least one of different radio ranges or different transmission intervals.

8. The method according to claim 7, which further comprises providing the at least two different radio modes with at least one of a short range mode, or a middle range mode or a long range mode as different radio ranges.

9. The method according to claim 1, which further comprises transmitting redundancy-related data in the uplink telegram in the default setting of the application layer of the at least one radio node, and reducing or no longer including the redundancy-related data in the uplink telegram when the setting of the application layer in the at least one radio node is changed.

10. The method according to claim 9, which further comprises providing the redundancy-related data as consumption levels at least at two different reading times or due dates.

11. The method according to claim 1, which further comprises performing the change of the setting of the application layer in the at least one radio node when at least one of:
the at least one radio node sends uplink telegrams using at least two different radio modes in the default setting of the application layer and uplink telegrams of at least one of the radio modes are received by the gateway, or
the at least one radio node sends uplink telegrams using at least two different radio modes in the default setting of the application layer and uplink telegrams of at least one radio mode are not received by the gateway, or
the at least one radio node sends uplink telegrams with redundancy-related data in the default setting of the application layer during normal operation and a headend confirms receipt of the redundancy-related data.

12. The method according to claim 1, which further comprises:
providing the change of the setting of the application layer of the at least one radio node with no time limit, or
providing the change of the setting of the application layer of the at least one radio node with a time limit, and subsequently switching the at least one radio node back to normal operation.

13. The method according to claim 12, which further comprises switching the at least one radio node back to normal operation when the at least one radio node has received a corresponding downlink command, or when the at least one radio node has not received a downlink command within a specified period of time.

14. The method according to claim 1, which further comprises providing at least one fixed or mobile gateway as the at least one gateway.

15. The method according to claim 1, which further comprises carrying out the radio communication in the 868 MHz frequency band.

16. A radio communication network, comprising:
at least one radio node;
at least one gateway; and
a headend;
the at least one radio node and the at least one gateway conducting a bidirectional radio communication therebetween according to claim 1.

17. The radio communication network according to claim 16, which further comprises a battery operating the at least one radio node.

18. A radio node, comprising means for conducting a bidirectional radio communication according to claim 1.

19. The radio node according to claim 18, wherein the change of the setting of the application layer is implemented in firmware of the at least one radio node and is triggerable by a downlink command.
